(19) United States
(12) Patent Application Publication
(10) Pub. No.: US 2010/0274647 A1
(43) Pub. Date: Oct. 28, 2010

(54) Marketing System and Method Benefiting Both Buyers and Businesses Alike

(76) Inventor: Christopher Earle, Cocoa, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/765,489

(22) Filed: Apr. 22, 2010

Related U.S. Application Data
(60) Provisional application No. 61/171,605, filed on Apr. 22, 2009.

(51) Int. Cl. G06Q 30/00; G06Q 10/00; G06Q 40/00; G06F 17/30

(52) U.S. Cl. 705/14.13; 705/14.16; 705/14.17; 705/14.19; 705/14.23; 705/14.26; 705/14.27; 705/14.35; 705/14.36; 707/722; 707/769; 707/E17.018; 707/E17.014

(57) ABSTRACT

System and method for providing value to both buyers and businesses. Businesses provide value to buyers by providing a searchable database containing member businesses and their products and services. Businesses also provide discounts and specials to buyers as an added incentive. Businesses are provided a means to display their goods and services to a targeted group of motivated buyers searching within the system of the present invention, wherein discounts and specials influence a buyer to transact with a member business rather than a non-member business. The searchable database of the present invention may provide results for buyer search requests pertaining to local zip codes of member businesses, product or service categories, product or service descriptions, and the like. Member businesses may be required to maintain a minimum level of incentives available to member buyers, such as offering at least one buy one get one free offer to member buyers.

### CROSS REFERENCE TO RELATED APPLICATIONS

This application claims the benefit of provisional patent application Ser. No. 61/171,605, filed with the USPTO on Apr. 22, 2009, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a marketing system and method, more specifically, the present invention relates to a system and method for marketing business products and services to potential buyers via a searchable database that attracts motivated buyers via deals and other incentives.

2. Background Art

Businesses utilize various techniques to market products and services to potential buyers. A common way to present buyers with additional options is through advertising. For example, when a buyer enters a search request for goods or services, the buyer is presented not only with search results satisfying the request, but also an advertisement, where the advertisement solicits the buyer to purchase similar or competitive goods or services from the advertiser. Further, Internet web sites typically sell advertising space to businesses, where a user accessing a web site will also receive an embedded advertisement. In particular, banner ads or pop-up ads are frequently utilized on the Internet for targeted advertising. Advertisers are willing to spend various amounts for a particular ad depending on the cost-per-thousand (CPM) or cost-per-click (CPC) value associated with the ad.

Businesses can target products or services to buyers based on particular criteria, such as types of web sites visited or products requested. Businesses can also target products or services based on the buyer's demographics, such as economic levels, geographic areas, or age ranges. Additionally, businesses can reduce marketing costs by utilizing targeted advertisements, as only those buyers that are most likely to respond to the ad are targeted. Businesses can also provide gifts, offers, and rewards at market value based on other similar offers from other businesses. By providing targeted advertising, businesses can also reduce the likelihood that buyers will receive unwanted advertisements, while also providing efficient and creative delivery of gifts, offers, and rewards to buyers that are of high interest to the buyer. Businesses can enter into partnership agreements that allow businesses to provide referrals or alternatives for products or services that it may not have been otherwise able to provide.

Marketing not only provides a vehicle for businesses to sell products and services, but buyers may also benefit from business marketing. For example, marketing can provide the buyer with information and discounts meeting the current buyer needs. Similarly, businesses can provide similar or related products or services through cross-marketing that the buyer may not have otherwise been aware of. In addition, businesses can provide the buyer with a centralized shopping experience that allows buyers the convenience of making several purchases or inquiries at one location, such as at a web site. Businesses may also provide special gifts, offers, or rewards to the buyer in response to visiting the business' web site or making particular purchases (e.g. buy one get one free). Moreover, businesses can provide buyers with competitive offers from various businesses for the same goods or services such that buyers will have different options from which to choose.

One specific marketing technique is a gift book, which can include several offers, gifts, coupons, promotions, or rewards that businesses provide to consumers, such as a consumer that recently moved into a particular area. For example, the gift book could include coupons for specific restaurants that are located within the same area as the consumer's new home. The gift book might also contain other information about the consumer's new residential community as well as information about other products or services offered within or near the area. The coupons, promotions, and rewards included in the book regarding the featured businesses typically are arranged in advance through contractual relationships between the businesses and a service provider, such as a web site utilizing an interface for consumers to view and access various information and offers provided by the businesses. In this manner, not only does the service provider urge increased visits to its web sites, it also has created an ad revenue vehicle from third-party advertisers who wish to be featured on the web site.

Despite these improvements in providing targeted advertisements to potential consumers, there is a need for an improved marketing system that not only provides businesses with a vehicle for increasing consumer interest but also the likelihood that the marketing will result in providing a product or service to a consumer. Conventional marketing schemes do not prevent the consumer from being overwhelmed with similar advertisements and do not necessarily result in the consumer receiving the most desirable gift, offer, or reward. Moreover, there is a need for targeted advertising that allows consumers to efficiently manage various gifts, offers, and/or rewards.

It would therefore be advantageous to provide a system and method for providing targeted advertisements to consumers that increases consumer interest and need in goods and/or services. In addition, it would be advantageous to provide a system and method for facilitating the management of various gifts, offers, and/or rewards.

### BRIEF SUMMARY OF THE INVENTION

In accordance with one embodiment of the present invention, a method of marketing and promoting goods or services from a plurality of member businesses to a plurality of member buyers, the method comprising the steps of receiving member business information from at least one of the plurality of member businesses, storing the member business information in a database, receiving member buyer information from at least one of the plurality of member buyers, storing the member buyer information in the database, receiving search criteria from the at least one of the plurality of member buyers, searching the database for products or services matching the search criteria, displaying a search results page to the at least one of the plurality of member buyers, wherein the search results page contains at least one search result, providing a coupon link associated with each of the at least one search result, receiving an election of the coupon link from the at least one of the plurality of member buyers, populating a coupon associated with the coupon link with a unique code, and providing the coupon in a printable format to the at least one of the plurality of member buyers.

In accordance with another embodiment of the present invention, a system for marketing and promoting goods or services from a plurality of member businesses to a plurality of member buyers, the system comprising an interface in the form of a web site configured to provide a plurality of web pages displayable to the plurality of member businesses and the plurality of member buyers; an online accessible database associated with the interface, wherein the online accessible database performs the steps of receiving member business information from at least one of the plurality of member businesses, storing the member business information in the online accessible database, receiving member buyer information from at least one of the plurality of member buyers, and storing the member buyer information in the online accessible database; and a computer system associated with both the interface and the online accessible database, wherein the computer system performs the steps of receiving search criteria from the at least one of the plurality of member buyers, searching the online accessible database for products or services matching the search criteria, displaying a search results page to the at least one of the plurality of member buyers, wherein the search results page contains at least one search result, providing a coupon link associated with each of the at least one search result, receiving an election of the coupon link from the at least one of the plurality of member buyers, populating a coupon associated with the coupon link with a unique code, and providing the coupon in a printable format to the at least one of the plurality of member buyers.

### BRIEF DESCRIPTION OF THE DRAWINGS

A better understanding of the present invention will be realized from the detailed description that follows, taken in conjunction with the accompanying drawings, in which:

FIG. 1 depicts an embodiment of a home page of a web site providing a system and method of the present invention.

FIG. 2 depicts a preferred embodiment of a home page of a web site providing a system and method of the present invention.

FIG. 3 depicts an embodiment of a generalized business or vendor sign-up web page of the system and method of the present invention.

FIG. 4 depicts a preferred embodiment of one web page of a plurality of business or vendor sign-up web pages of the system and method of the present invention.

FIG. 5 depicts a preferred embodiment of another web page of a plurality of business or vendor sign-up web pages of the system and method of the present invention

FIG. 6 depicts a preferred embodiment of still another web page of a plurality of business or vendor sign-up web pages of the system and method of the present invention

FIG. 7 depicts multiple embodiments of category classifications and potential associated sub-category classifications that may be utilized within the searchable database of the system and method of the present invention.

FIG. 8 depicts an embodiment of a generalized buyer or consumer sign-up web page of the system and method of the present invention.

FIG. 9 depicts a preferred embodiment of a buyer or consumer sign-up web page of the system and method of the present invention.

FIG. 10 depicts a flow diagram of an embodiment of generalized method steps of the present invention.

FIG. 11 depicts a preferred embodiment of a member buyer profile page of the system and method of the present invention.

FIG. 12 depicts a preferred embodiment of a search results display page of the system and method of the present invention.

FIG. 13 depicts a preferred embodiment of a search results display page of the system and method of the present invention overlain by a printable coupon window.

FIG. 14 depicts a preferred embodiment of a printable coupon of the system and method of the present invention.

FIG. 15 depicts a flow diagram of an embodiment of more detailed method steps of the present invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

In the present disclosure “member buyer” means any consumer or shopper that has completed the sign-up or registration process with the system of the present invention.

In the present disclosure “member business” means any vendor or business entity that has completed the sign-up or registration process with the system of the present invention.

In the present disclosure “member credit provider” means any credit provider or other lending institution that has completed the sign-up or registration process with the system of the present invention.

The present invention may help connect buyers, businesses, and credit providers in a unique and dynamic way. Each participant within the system and method of the present invention receives value to further drive use and growth of the present inventive system. Buyers may receive discounts or other incentives when purchasing from member businesses, access to a searchable database to more easily find desired products or services fitting buyer criteria, and special rates, discounts, or other provisions from member credit providers. Businesses may receive the ability to market their respective goods or services to motivated member buyers thus alleviating much of the wasteful costs found in widespread marketing campaigns. Credit providers may receive the ability to market their credit cards or other credit services to motivated member buyers actively engaged in retail commerce.

The advent of Internet retailers such as AMAZON.COM and their rapid growth and success has permanently altered the sales and marketing landscape. A small percentage of buyers may refrain from online purchases or making online price comparisons for desired goods or services. However, the vast majority of buyers utilize the Internet for at least a portion of their search for the best deal or value regarding a specific product or service that they desire. Retailers hoping to either maintain or increase their buyer market base must inevitably turn to some form of Internet representation and/or marketing. The present invention provides a system and method for bringing together motivated buyers and businesses that are willing to offer specific discounts and incentives in order to be listed in a buyer searchable database. Buyers will benefit from the deals and incentives they receive when transacting with a member business from within the searchable database and member businesses will be able to target motivated buyers actively seeking products or services offered by the member business. As an added benefit, a member credit provider may offer special discount rates or other credit services to buyers utilizing the system of the present invention.

Every buyer desires to get the best deal or value possible when purchasing products or services. Whether they scour Internet search engines or review newspaper advertisements, a majority of buyers gain reassurance from knowing that they have found the best available value for their upcoming purchase. If a specific location were to continually offer a standardized incentive or deal such as highly valued “buy one get one free” offers from a wide variety of businesses, buyers would surely visit such a location in their search for the best deal or value regarding any upcoming purchase. While local print media provides adequate coverage, an Internet location would allow for much broader dissemination of the standardized deals or incentives offered by the member businesses to the member buyers. While zip code criteria may be incorporated to find member businesses within geographic proximity of the member buyer, the searchable database may also show online retail member business results to provide the complete scope of deals or incentives available to the buyer. Member buyers may then have the option of choosing either a local member business or online member business offering the best incentive or deal for their upcoming purchase. The scope of the present invention also includes the options of methods incorporating regionalized print versions, accessibility with .mobi capable device (e.g. mobile telephones), and the like. In one example with .mobi capable devices, a member buyer who is located in either a familiar or unfamiliar geographic location may utilize the system and method of the present invention via a cellular phone to find the nearest member business offering a desired product or service associated with at least one incentive or deal.

Buyers that sign up and register for the system of the present invention gain several benefits upon becoming member buyers. Member buyers are allowed access to a searchable relational database containing products, product categories, product descriptions, deals and other incentives, and associated member business listings that may meet or match a member buyer's selected search criteria. Member businesses of the system of the present invention may be required to provide at least one specific incentive (e.g. buy one get one free) to member buyers as part of the business sign-up or registration agreement. In this manner, member buyers are guaranteed to have at least the required minimum specific incentive available from each of the member businesses. Such a searchable database of deals and incentives may make each member buyer's search for the best deal or value regarding the desired product or service more timely and efficient. The member buyers may also appreciate the fact that their use of the present inventive system may be tied to charitable donations and other meaningful causes. As one example, a predetermined level or percentage of net income generated by the system of the present invention may be donated to local schools or one or more other charities or non-profit organizations. In one embodiment, a specified percentage of net profits may be given back to the local educational community within any given zip code. Purchase and coupon redemption amounts may be trackable within the relational database of the present inventive system. Other options include but are not limited to future partnerships and matching programs with large scale vendors, such as DELL or APPLE, to provide a matching level of technology donation to the local community. Such charitable aspects help drive local use and provide for a fundraising platform at the local level. Large scale vendors and member businesses may thereby be given the opportunity to be seen and heard at the grass roots level.

Member credit providers, such as banks, credit unions, credit card companies and the like may provide further benefits to member buyers. Such member credit providers, in exchange for their access to member buyers researching upcoming purchases, may offer special rates, offers or other discounts to reward member buyers that register with the member credit provider. As an example, member credit providers may offer reduced fixed interest rates for member buyer purchases made with any member business. Member credit providers may also offer no application fee and/or no annual fee as deals or incentives to entice member buyer registration with the member credit provider. A reward system may also be offered by the member credit providers wherein 5% of every dollar spent at any business or 10% of every dollar spent at a member business may be redeemable for other deals (such as buy one get one free offers) provided by member businesses of the present inventive system. The specific reward amounts and percentages may be freely customizable by the member credit provider. For marketing purposes, such a reward program or component may be labeled BOGOBUCKS or any other desired marketing label as an added means to attract member buyer attention and interest. To receive the deals and incentives offered by the member credit provider, a member buyer may be provided with an online link from the present inventive system to an online registration web page hosted by the member credit provider. Registration with the member credit provider may also be provided via postal mail and/or in-person appointments at a member credit provider's place of business. To receive the member credit provider's deals and other incentives, during the credit registration process a member buyer's unique customer number may be linked with their new credit account with the member credit provider.

In use, the computer system architecture used to implement the system and method of the present invention may generally be constructed from electronic components known to one skilled within the art. The novelty of the present invention exists in the method steps and available features and benefits provided by the present inventive system to its users.

An online accessible and searchable relational database is maintained to store information input into the present inventive system. Forms of stored input may include but are not limited to member business information such as physical address, store hours, telephone number, email address, web site address, business license number, corporate information, coupon information, additional business options, registration agreements, and credit card information; member buyer information such as customer number, buyer password, physical address, telephone number, and email address; member credit provider information such as physical address, store hours, telephone number, email address, web site address, business license number, corporate information, available credit rates, and discounted or waived service fees; and HTML links to relevant Internet web pages.

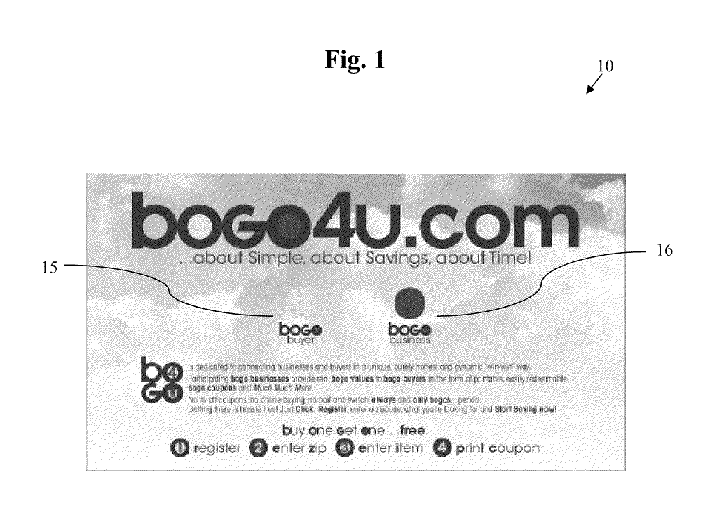

In one embodiment, a system of the present invention may provide for a member buyer interface and a member business interface via the Internet. As shown in FIG. 1, a home page 10 of such an Internet based system of the present invention may easily direct member buyers and member businesses to distinct web pages of interest for each classification of user. In the embodiment of FIG. 1, member buyers may need only selected the “BOGO Buyer” link or member buyer interface 15 to access member buyer information and functionality of the present invention. Likewise, member businesses need only select the “BOGO Business” link or member business interface 16 to access member business information and functionality of the present invention.

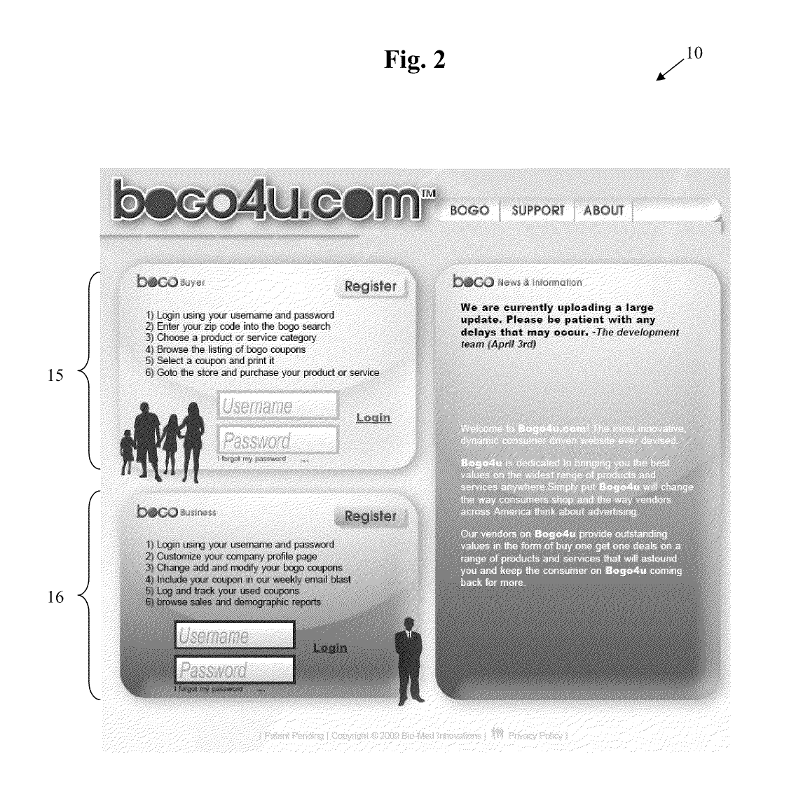

In a preferred embodiment, as depicted in FIG. 2, the home page 10 may comprise a member buyer interface 15 and a member business interface 16. Both the member buyer interface 15 and the member business interface 16 may allow new buyers or businesses, respectively, to register with the system of the present invention while also allowing existing member buyers and existing member businesses to login to an individual user profile via input of a username and password that has been registered with the system.

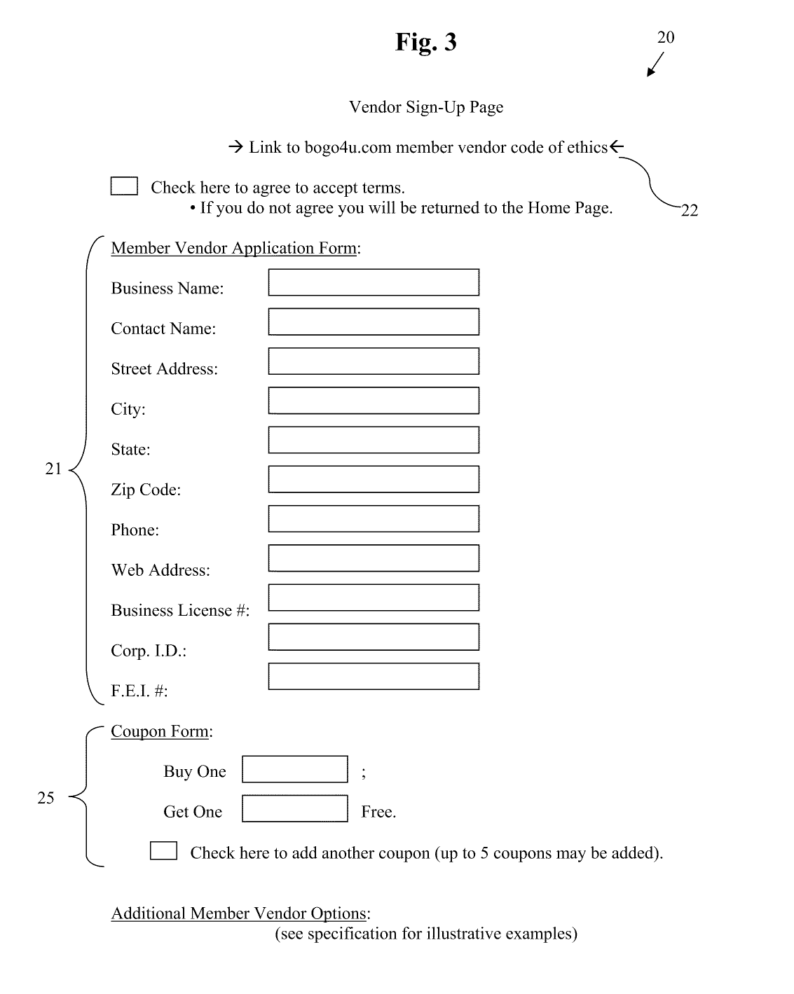

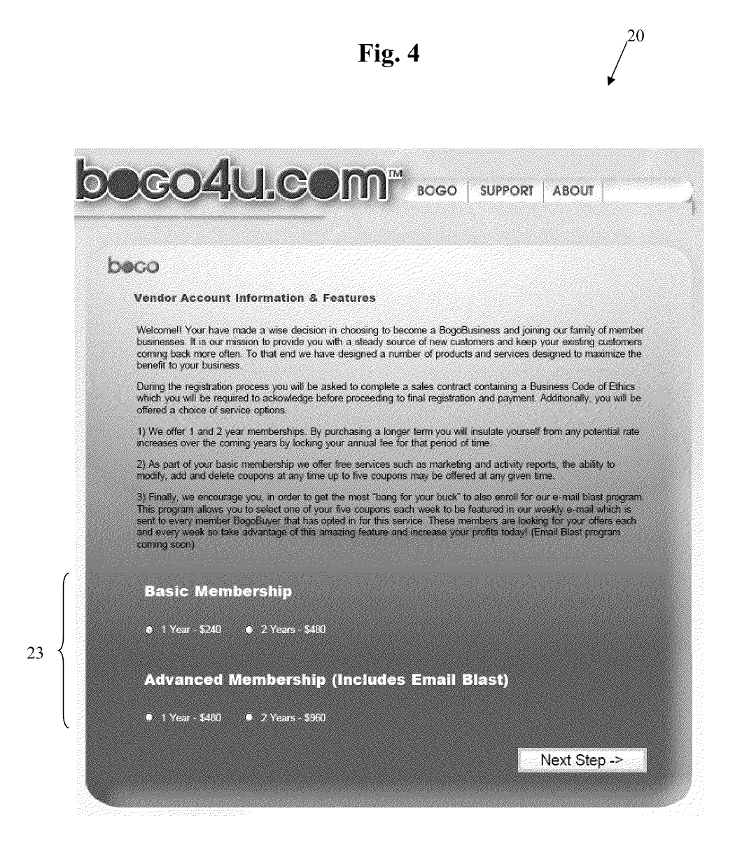

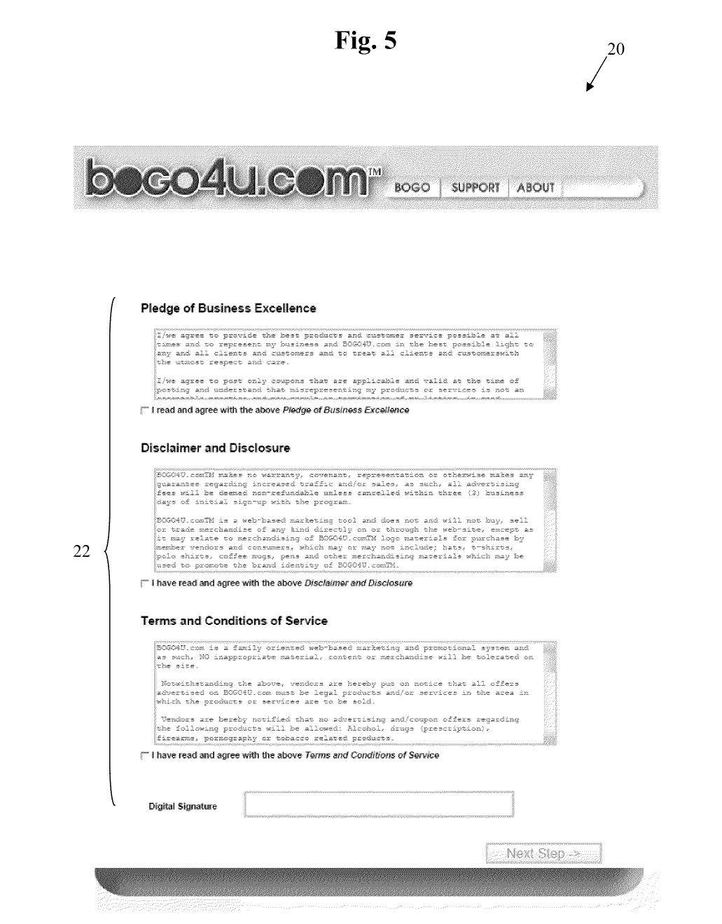

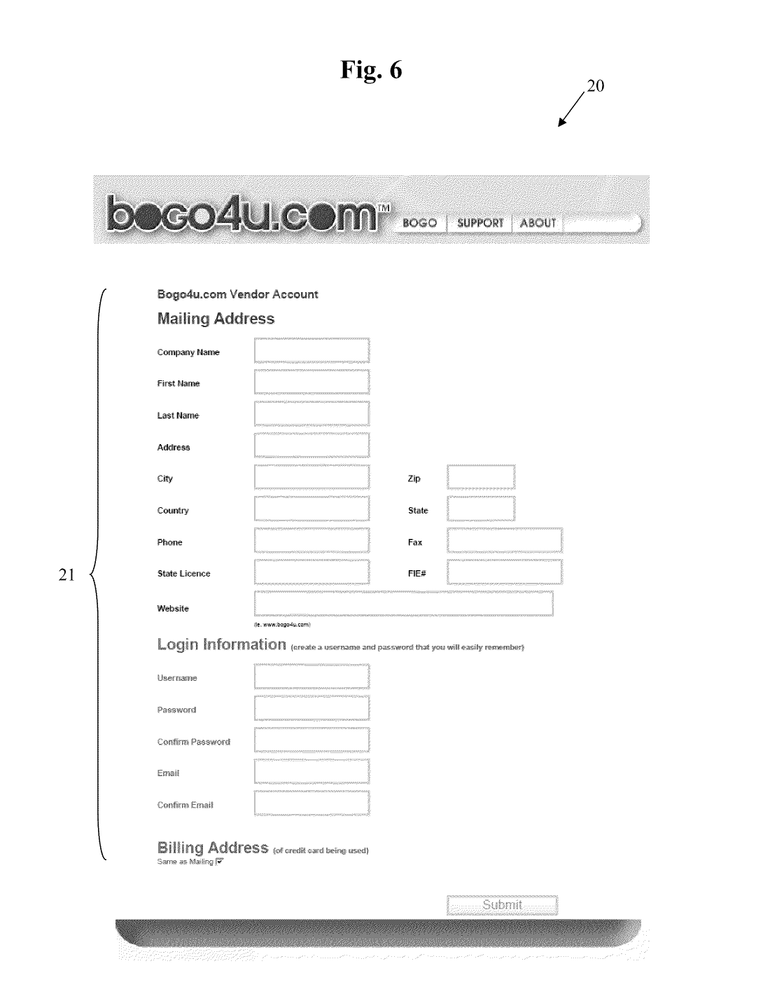

Member business information 21 is first collected and stored within the searchable database of the present invention. A generalized embodiment of a Business Sign-Up Page 20 of the present invention is illustrated in FIG. 3 while a preferred embodiment of a Business Sign-Up Page 20 may comprise a plurality of pages for collecting new business member information 21 as shown in FIGS. 4-6. As depicted in FIG. 3 and FIG. 5, potential new member businesses may be instructed to read and thereafter abide by the member business code of ethics 22 to maintain their member business status in good standing. A system administrator of the present invention may reserve the right, at his or her discretion, to limit or prohibit the products or services promoted under the system of the present invention. As an example, promotion of drugs, alcohol, tobacco, fire arms, or any combination thereof may be limited or banned at the discretion of the system administrator of the present invention.

As shown in FIG. 4, acceptance of the member business code of ethics 22 may include the payment of a predetermined subscription 23 fee for a designated amount of time. At the discretion of the system administrator, longer term subscription commitments may include a price reduction as compared to higher priced, shorter-term subscription commitments. Subscription lengths may comprise any lengths of time known within the art including but not limited to six month, one year, and two year subscription agreements. The fees for such subscriptions 23 may be dependent upon the number of member business locations used and the length of the selected subscription 23. By categorizing each member business location, the system of the present invention may track the usage and results for each member business location thereby providing extremely valuable business and marketing information to the member business.

The Business Sign-Up Pages 20 may further include specific fields designating at least one required incentive 25 or deal to be offered by each member business. In a preferred embodiment, the at least one required incentive 25 or deal comprises a buy one get one free offer for a product or service of the member business. The buy one get one free incentive need not be for an identical item, but at least for a second item of equal value. However, the at least one required incentive 25 or deal may be any incentive or deal known within the art and need not be restricted to buy one get one free offers of the preferred embodiment. It may be mandatory for the member business to offer the at least one required incentive 25 or deal, but each member business may have the option to offer more than the at least one required incentive 25 or deal to member buyers as well. Under the terms of the member business' registration agreement, the member business may be required to honor coupons for the at least one incentive 25 or deal through the termination of their subscription term with the system of the present invention.

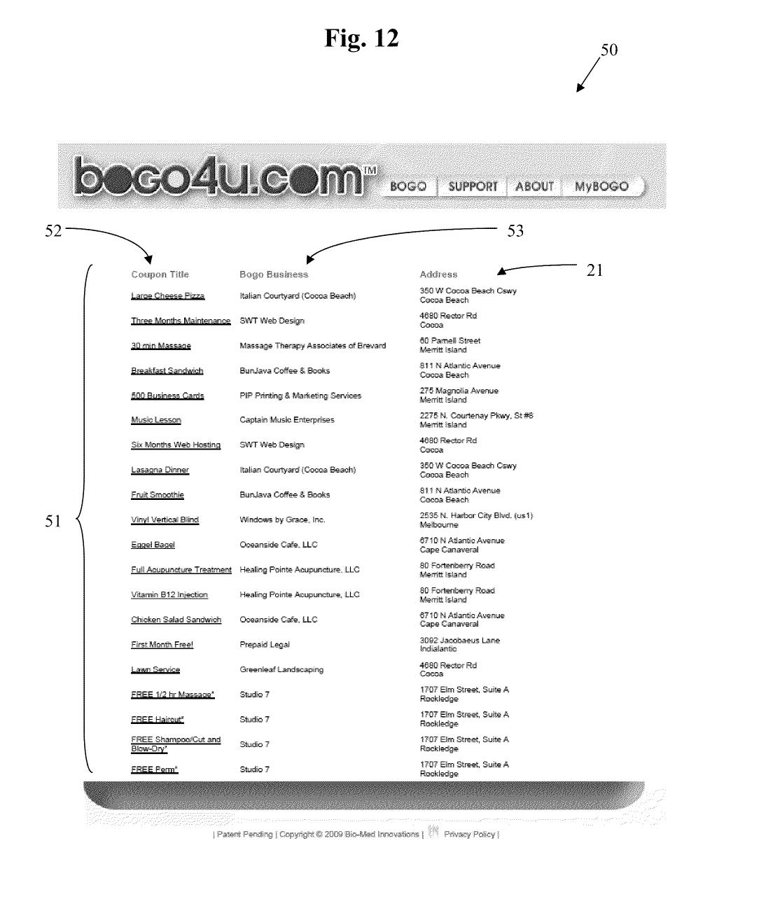

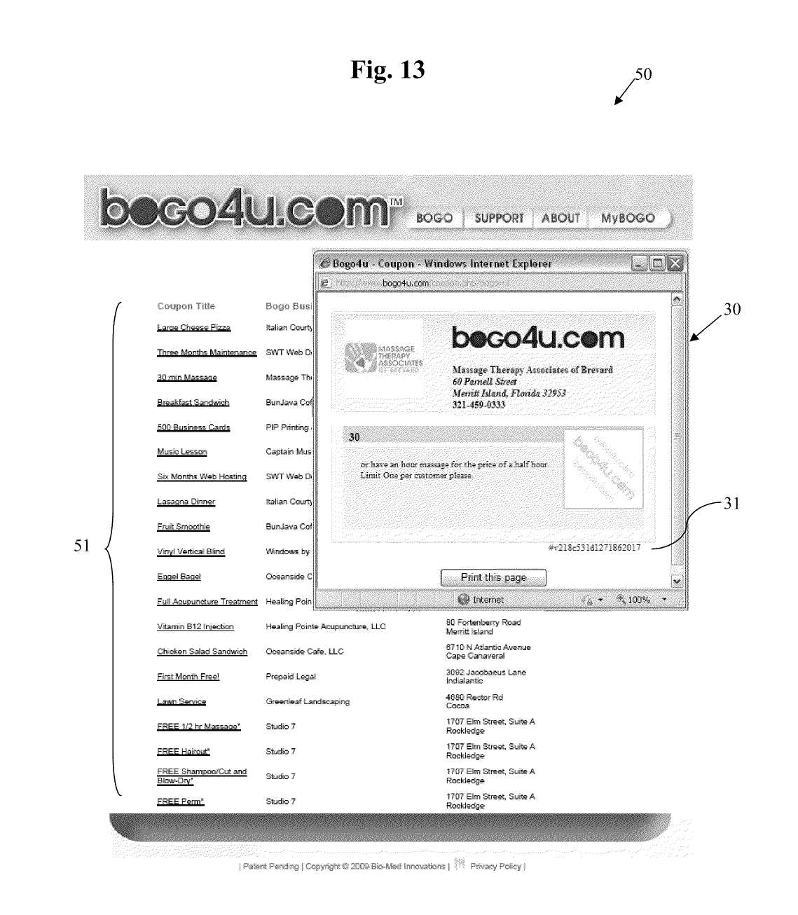

As shown in FIGS. 12-13, each member business coupon 30 selected by a member user may generate a unique code 31 or traceable set of numbers. In a preferred embodiment, a generated coupon 30 may comprise a member business' unique vendor number, a member buyer's unique customer number, and an expiration date for the generated coupon. The expiration date may be the same as the date of generation or any additional length of time desired by the member business. When a member business coupon 30 is redeemed, the system of the present invention may then invalidate the unique code 31 provided for that specific coupon 30. In this manner, any generated coupon 30 may only be used once and a member buyer may not make or distribute multiple working copies of the generated coupon 30.

Member businesses may also be capable of receiving immediate tracking information regarding the level of interest and effectiveness of any specific marketing campaign registered with the system of the present invention. The volume and time frame of generated coupons 30 and redeemed coupons 30 may be monitored for each respective business location. Such information may prove to be invaluable in assisting in the development of efficient and productive marketing and advertising campaigns.

The system of the present invention may further include additional member business options. Each member business may be given the option to participate in a periodic email blast to member buyers within the searchable relational database of the present invention. In a preferred embodiment, the email blast would occur on either a monthly or a weekly basis but any term or period may be employed within the scope of the present invention. Member business participation in the email blast option may require an additional fee such as a subscription fee for a predetermined period of time (e.g. one year commitment). During the business registration process or after a business has already become registered within the system, the member business may access and read information and explanations regarding the email blast option before choosing to pay any additional fee for the email blast service. In a preferred embodiment, the email blast is performed on an anonymous basis wherein the member business' emails are sent to member buyers within specifically designated zip codes, wherein a member business does not have direct access to the email addresses of the member buyers within the selected geographic region(s). As an alternative option, member businesses may opt-in for special mentions or listing as a “Featured Business” in periodic emails sent by the system to member buyers within a designated geographic region.

The system of the present invention may also offer a local print ad campaign to help member businesses further market their goods and services to potential buyers in specific geographic areas. Member businesses may selected between a wide variety of print ad campaign options including physical size of the print ad to be published, the duration of the print ad campaign, the geographic limitations or specificity of the print ad campaign, and the like. Options for the physical size of the print ad may include but are not limited to full page, half page, quarter page, eighth of a page, business card size, and any other print advertising sizes known within the art. Such member business additional services may be selected by means commonly employed in retail web sites including but not limited to radio buttons, check boxes, drop down selection menus, and the like. Geographic limitation of the print ad campaign may be selectable from a wide variety of options, with wider dissemination potentially carrying higher additional fees as determined by the system administrator. Print ad campaigns may be directed toward the zip code of the member business, zip codes specifically requested by the member business, from displayed zip codes geographically adjacent the member business's zip code, from one or more radius distances extending out from the member business's address, and the like.

In additional to print media, the scope of the present invention may further incorporate the ever-advancing use of mobile and wireless technologies. The present invention may further provide the ability to send mobile alerts, SMS messages, and the like to targeted groups of member buyers. Whether it be through print, Internet, or mobile technology, the system and method of the present invention can communicate marketing and advertising campaign information to target groups of prospective member buyers.

The business registration process may further include the option for each member business to participate in an additional reward program that provides redeemable points that are equivalent to a specified cash value. As discussed herein, such a reward system may be designated BOGOBUCKS or any other name for marketing purposes that is desired by the administrator of the present inventive system. Any BOGOBUCKS accumulated by a member buyer may be redeemable as cash value toward purchases made at member businesses. Methods of earning BOGOBUCKS through the reward system are disclosed in greater detail below.

The system of the present invention may additionally offer artwork consultation for member business print ad campaigns. Ad campaign consultations may be offered on a free basis, wherein any design and generation of artwork or construction of ads after the initial consultation may incur a separate fee. If a member business already has their print ad artwork or chooses to have another provider generate their artwork, such an additional member business option may be declined without accruing an additional fee.

During the business registration process, member businesses may further read and be made to affirmatively indicate that they understand that no warranty or guarantee is made by the administrator of the present inventive system that a member business' participation in the present inventive system insures that any member buyer will select the specific member business for a future purchase. Additionally, member businesses may affirm their understanding that they are purchasing advertising and agree to honor any incentives or deals that they offer through the system of the present invention.

At the conclusion of the business registration process or after updating the available options of a preexisting member business, a payment web page may conclude the registration or profile update process. The payment web page may incorporate any payment methods known within the art including but not limited to online credit card payment, online check payment via check and bank routing numbers, PAYPAL and other Internet payment agents, and the like.

By registering and becoming a member business each participating retailer gains a wide variety of advertising and marketing advantages not previously available within the marketplace. For a low-cost subscription fee, each member business may attain exceptional national exposure to the public on a local or national scale. Member businesses will share in the public perception of exceptional value and community goodwill related to the present invention that provides at least one required incentive or deal such as a buy one get one free incentive available from each member business. Additionally, member businesses will also share in the exposure impact created by the viral marketing, email blast, and other national media solicitations generated by the present invention.

Smaller member businesses may now also be on level footing with their much larger member business competitors. In one embodiment, the system may provide uniform pre-populated business ads and/or coupons so that no business ad is bigger or more creative that its competitor. Member business competition may be based solely on the at least one required incentive or deal that is offered and the member business' specific zip code. The present invention gives member business a high level of control over their promotions and incentives. Member businesses may have the ability to freely change the at least one required incentive or deal they are offering, and the pre-populated coupons eliminates the delay in waiting for advertising proofs, any necessary marketing approvals, and the like. Additionally, the traceable coupon redemption system provides each member business with a means to increase their volume of consumer traffic while also allowing the member business to test the popularity of a product or service within a specific geographic market area.

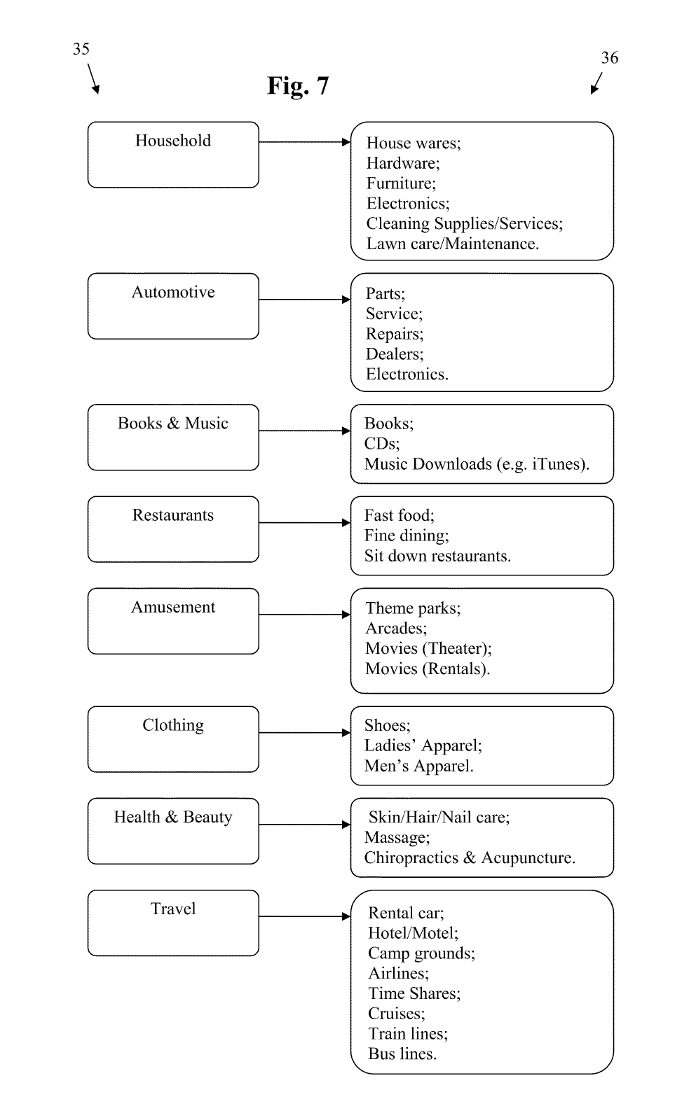

The searchable database of the present invention allows member buyers to input search criteria as a means to narrow their search to specific products, member businesses, and/or geographic locations of interest. FIG. 7 illustrates one embodiment of potential category and sub-category listings within which member business products and services may be cataloged. Such a classification system may be created and freely customized by the system administrator, wherein FIG. 7 depicts just one embodiment of potentially limitless variations of categories and/or sub-categories that may be used. As further examples, other potential categories may include but are not limited to Luggage & Storage, Toys, Gifts & Collectibles, Musical Instruments, Sporting Goods, Jewelry & Watches, and the like. Member buyers may also query the searchable database via product descriptions, member business information, geographic location, and the like. As part of the business registration process, each member business may input descriptions of their products or services offered via the system of the present invention, member business information 21, and member business or product location (e.g. zip code or area code), and the like. Such information is stored within the searchable relational database and may be queried via member buyer specified search criteria.

The member buyer search process may occur through one or more search criteria selections being made to narrow the matching search results. As an example, the member buyer may first select one or more zip codes for the desired goods or services. After selecting the geographic limitation, the member buyer may then select the general product or service category in which they have an interest. A listing may then be displayed showing all incentives or deals related to the zip code and product selected. Finally, the member buyer may then select a desired incentive or deal (one at a time) to generate a redeemable coupon 30. Both the number and order of the search criteria selections may be variable and the scope of the present invention comprises any such selections known within the art and any combinations thereof.

The selection of a specific search result may generate a unique and redeemable coupon 30. The coupon 30 may be pre-populated with a unique code 31 that may comprise at least the member business' unique vendor number, the member buyer's unique consumer number, and the expiration date of the coupon. The coupon's expiration date may be the same day as its generation or any time period thereafter that is acceptable to the specific member business. The member buyer need only print the coupon 30 and redeem it at a place of business of the member business before the coupon's expiration date. In a preferred embodiment, each member buyer may only redeem one coupon 30 per member business campaign. Printing more than one coupon 30 for a specific member vendor campaign is moot since each coupon is pre-populated with a unique identifiable code 31. However, in other optional embodiments each member business may supersede the “single use rule” and allow for more than a single use of a coupon 30 by a member buyer within a member business' campaign.

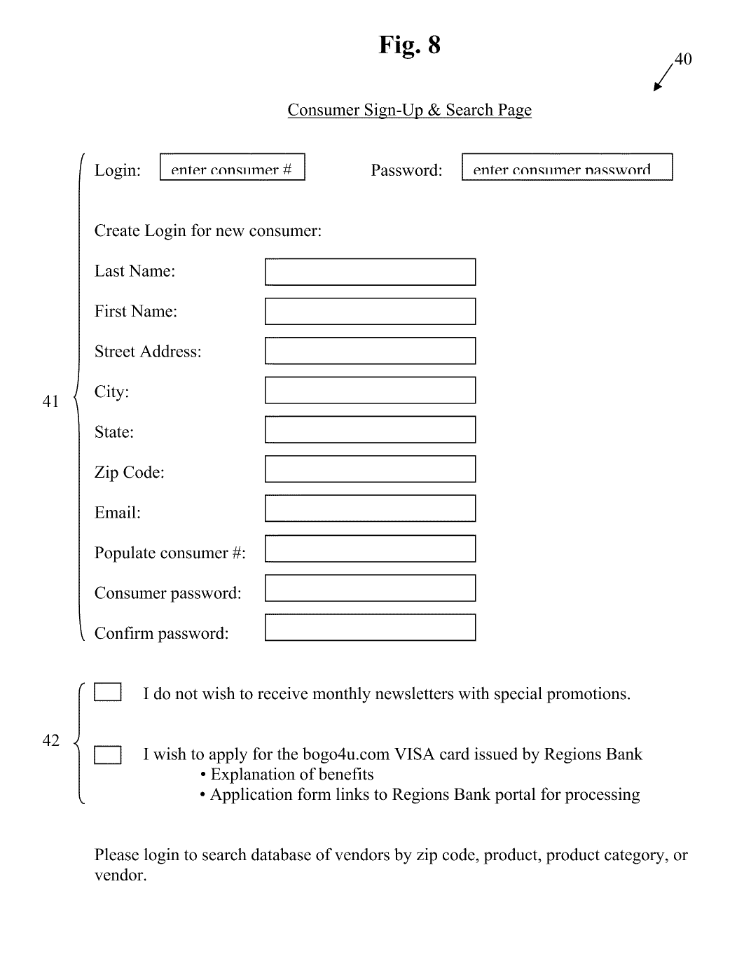

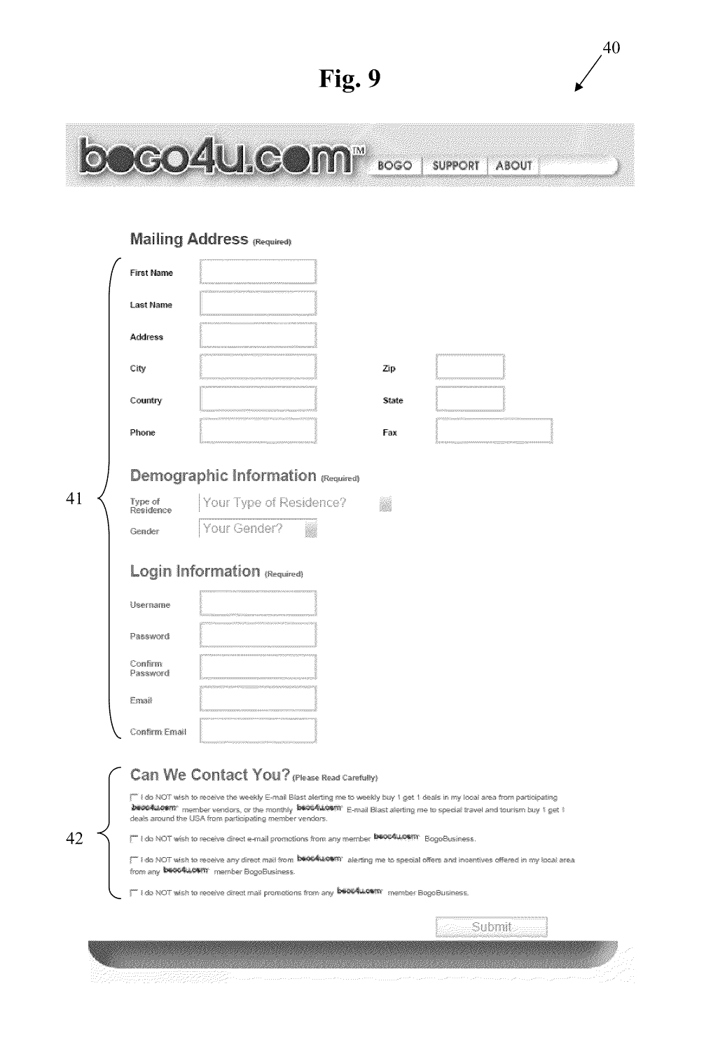

With product and member business information 21 being stored within the searchable database, prospective member buyers need to register a user profile to utilize the system and method of the present invention. FIG. 8 illustrates a generalized Consumer/Buyer Sign-Up Page 40 with which a buyer may input pertinent and/or required member buyer information 41 including but not limited to their name, address, telephone number, email address, login name or customer number (for already registered buyers), and the like. The buyer sign-up page 40 may offer other member buyer options 42 including receipt of monthly newsletters, application for credit with member credit providers that may offer their own incentives such as low fixed rates, and the like. In a preferred embodiment, the buyer sign-up page 40 may comprise member buyer information 41 and member buyer options 42 as shown in FIG. 9.

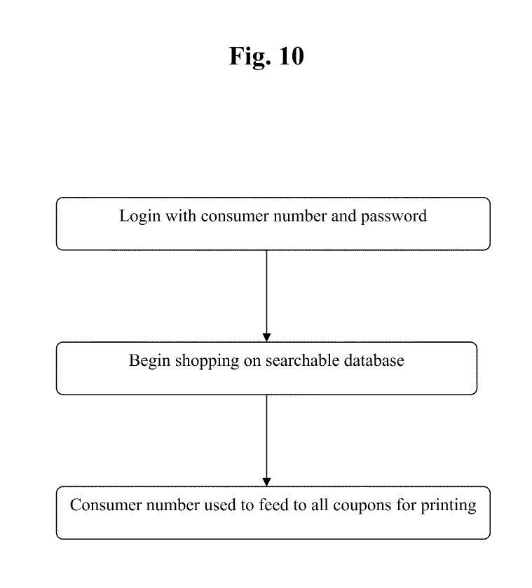

Each member buyer will have a customer number, other unique login identifier, or username. As generally shown in FIG. 10, the system of the present invention may utilize the member buyer's customer number during login to pull up past saved searches or information provided by the member buyer and as a means to save and record any future searches or information input by the member buyer. The system may also allow for real-time tracking and display of the total amount saved by each member buyer. To this end, member merchants may enter and/or otherwise associate the retail price of the product or service being offered in the trackable coupon to member buyers.

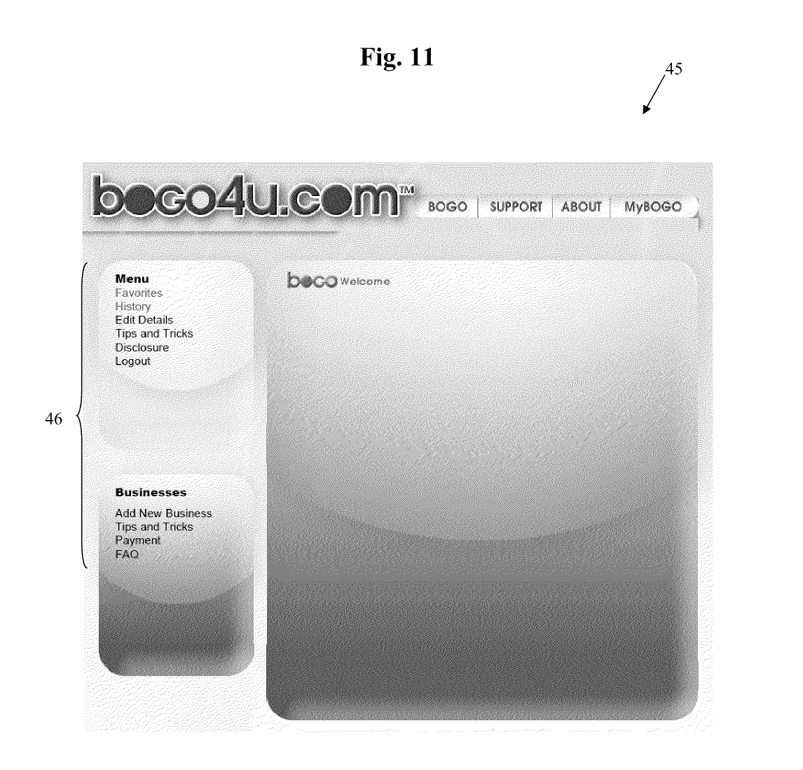

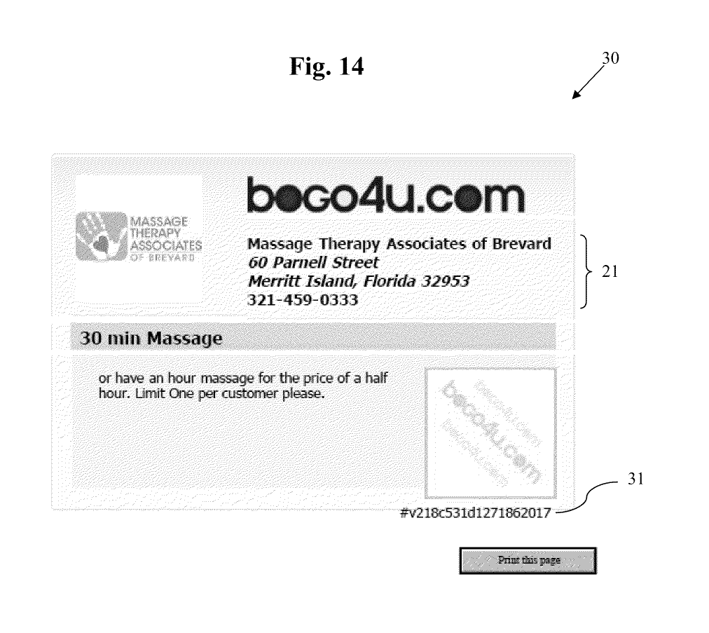

After logging in, as shown in FIG. 11, the member buyer may access a member buyer profile page 45 having menu options 46 to manage and otherwise use their member buyer account. The member buyer may begin shopping and enter any desired variety of search criteria to query the relational database of the present inventive system. An exemplary search results page 50 is depicted in FIG. 12. The search results page 50 comprises a plurality of search results 51 that may include coupon links 52, a listing of associated member businesses 53, additional member business information 21, and the like. When the member buyer finds an incentive or deal that they wish to take advantage of, the member buyer need only click on the coupon link 52 of their choice. As shown in FIG. 13, the system of the present invention may then utilize the member buyer's customer number or unique code 31 to populate information within a coupon 30 or other means of securing the offered incentive or deal. The member buyer may then print the coupon 30 for redemption at the selected member business. Selecting the coupon link 52 for the offered incentive or deal may additionally, or alternatively, generate a link to the selected member business' online retail site providing the selected incentive or deal, forward an email to the member buyer's personal email address containing either a link to the member business' online retail site, a file attachment of a printable coupon 30, or a link providing a printable coupon 30 for later use, and the like. In a preferred embodiment, as shown in FIG. 14, once a member buyer acts to secure a specific incentive or deal of interest by its coupon link 52, the system of the present invention populates an immediately printable coupon 30 having at least a portion of the member business information 21 and/or member buyer's provided information (e.g. vendor number and customer number/unique code 31) printed thereon. Additionally, an email notification may be automatically generated and sent to the member business after a member buyer elects to print a coupon 30 pertaining to that specific member business. The email to the member business may comprise a link to redeem the trackable coupon 30 after the coupon 30 has been received by the member business.

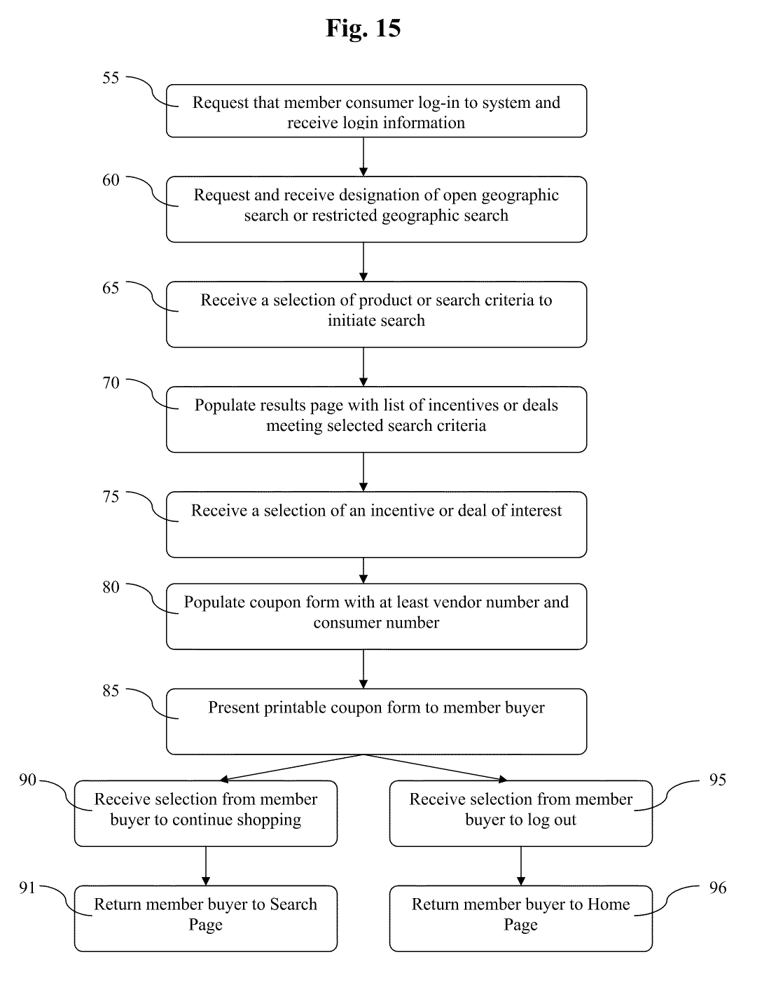

In use and as depicted in FIG. 15, one embodiment of the present system and method may request 55 a member buyer to login to the system using their unique customer number and password. The member buyer may then continue with a system wide query of intended search criteria or the member buyer may be requested 60 to choose to geographically restrict the search to one or more zip codes, area codes, or by a distance radius from the member buyer's place of residence. The system may then receive 65 a member buyer selection of one or more search criteria with which to initiate their search query. After querying the information stored on the searchable relational database of the present invention, the system of the present invention may populate 70 one or more result pages with a list of deals or incentives meeting the member buyer's selected search criteria. The system of the present invention may then receive 75 a member buyer selection of an incentive or deal of interest and the system may populate 80 information field(s) of a coupon form having at least the member business' vendor number, the member buyer's customer number, and/or a unique code 31 printed thereon. The system may then present 85 a printable coupon to the member buyer. The member buyer may then select 90 to continue shopping and be returned 91 to the search page to select another incentive or the member buyer may select 95 to exit the system or log out and be returned 96 to the home page of the system.

The reader will see that, according to one embodiment of the invention, the present invention provides for a mutually beneficial buyer and business marketing system and method that allows for growth and expansion on a variety of levels. While the system of the present invention may be marketed and advertised to non-member buyers while using various Internet search engines, viral marketing strategies may also be incorporated to expand the member buyer base as well as the member business base to the benefit of both member buyers and member businesses alike. In this manner during their use of the present inventive system, member buyers may be prompted to pass along registration links to other non-member buyers or to recommend non-member businesses that the member buyer would like to receive incentives or deals from over the system of the present invention. Likewise, member businesses may be prompted with the option to recommend the present inventive system to non-member buyers as a means for the new buyers to gain access to member business discounts available only through the present inventive system.

The system of the present invention may also offer a referral rewards program to further incentivize member buyers to refer potential new buyers to the system. Several examples are disclosed herein; however, the scope of the present invention includes award threshold levels that may be freely customizable and the value or size of such awards may also be freely scaled up or down as desired. In one example, member buyers referring one hundred new member buyers to the system may receive a $100.00 gift card, such as a VISA gift card. In another example, a member buyer referring ten newly registered and subscription-paid business members may receive a $250.00 gift card, such as a VISA gift card. Similarly, a member business referring ten newly registered and subscription-paid business members may receive a free basic subscription for one year and referring twenty new business members may be rewarded with either a two year free basic subscription or a free basic subscription with email blast functionality for one year. Churches and other non-profit organizations may also find it highly beneficial to register their organization as a member buyer and use the referral rewards program of the present invention as a fundraising option by having its volunteers or members actively recruit new referrals to the system of the present invention. As an example of a reward scheme for such a scenario, for every one hundred new member buyers that register with the system and are designated as being “referred by” a specific non-profit organization that non-profit organization may receive a $100.00 donation as their reward for the new member buyer referrals. Similarly, any non-profit organization referring ten newly registered and subscription-paid business members may result in a $250.00 donation being made to the non-profit organization as their reward for the new member business referrals.

In additional to redeemable coupons and a referral rewards program, member buyers may have the option of enrolling in a secondary reward system. Reward points, or BOGOBUCKS, may be awarded and redeemable as cash for purchases made from member businesses. The reward points may be acquired in a variety of ways including but not limited to referring new member buyers to the system of the present invention (new member must reference referring member's customer number), allowing statistical information (anonymously collected) from their registration information to be used by the system, taking part in periodic system surveys, opting-in for email contact from the system regarding news and member business listings, applying for and each subsequent use of a credit line offered by a member credit provider, and the like.

The present invention provides a multifaceted approach to motivate both member buyers and member businesses to both use and actively expand the system of the present invention. Required incentives or deals, referral rewards programs, targeted marketing options, and buyer demographic information available from the system are only several factors that provide a mutual benefit for both member buyers and member businesses to remain enrolled and participate in the method and system of the present invention.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the full scope of the present disclosure and legal equivalents thereof, and not by the few merely illustrative examples given.

What is claimed is:

1. A method of marketing and promoting goods or services from a plurality of member businesses to a plurality of member buyers, said method comprising the steps of:
receiving member business information from at least one of said plurality of member businesses;
storing said member business information in a database;
receiving member buyer information from at least one of said plurality of member buyers;
storing said member buyer information in said database;
receiving search criteria from said at least one of said plurality of member buyers;
searching said database for products or services matching said search criteria;
displaying a search results page to said at least one of said plurality of member buyers, wherein said search results page contains at least one search result;
providing a coupon link associated with each of said at least one search result;
receiving an election of said coupon link from said at least one of said plurality of member buyers;
populating a coupon associated with said coupon link with a unique code; and
providing said coupon in a printable format to said at least one of said plurality of member buyers.

2. The method of claim 1, further comprising the step of:
requiring said at least one of said plurality of member buyers to input a username and password prior to said displaying of said search results page.

3. The method of claim 1, wherein said step of receiving said search criteria further comprises receiving a geographic limitation.

4. The method of claim 1, further comprising the step of:
requiring each of said plurality of member businesses to provide at least one buy one get one free incentive to said plurality of member buyers.

5. The method of claim 1, further comprising the step of:
requiring each of said plurality of member businesses to provide at least one buy one get one free incentive via said coupon.

6. The method of claim 1, wherein said unique code comprises a vendor number and a customer number.

7. The method of claim 6, wherein said unique code further comprises an expiration date for said coupon.

8. The method of claim 1, further comprising the step of:
querying said at least one of said plurality of member buyers regarding whether said at least one of said plurality of member buyers wishes to continue shopping;
receiving a confirmation that said at least one of said plurality of member buyers wishes to continue shopping; and
displaying a search page to said at least one of said plurality of member buyers.

9. The method of claim 1, further comprising the step of:
querying said at least one of said plurality of member buyers regarding whether said at least one of said plurality of member buyers wishes to stop shopping;
receiving a confirmation that said at least one of said plurality of member buyers wishes to stop shopping; and
displaying a home page to said at least one of said plurality of member buyers.

10. The method of claim 1, wherein said coupon is redeemable only once.

11. The method of claim 1, wherein said member business information comprises at least a searchable description of said goods or services offered by said at least one of said plurality of member businesses.

12. The method of claim 1, further comprising the step of:
offering lender benefits to said at least one of said plurality of member buys from a plurality of member credit providers, wherein said lender benefits are selected from the group consisting of fixed interest rates, waiver of an application fee, and waiver of an annual fee.

13. The method of claim 1, further comprising the step of:
offering one or more referral rewards to each of said plurality of member buyers or to each of said plurality of member businesses that refer a specified total number of new member buyers or new member businesses to the marketing system.

14. The method of claim 5, wherein each of said plurality of member businesses offers one or more incentives in addition to said at least one buy one get one free incentive.

15. The method of claim 1, further comprising the step of:
invalidating said unique code on said coupon after said coupon is redeemed at said member business thereby allowing only one-time-use of said coupon.

16. The method of claim 1, further comprising the step of:
tracking the totals of printed said coupons for each of said plurality of member businesses.

17. The method of claim 1, further comprising the step of:
tracking the totals of redeemed said coupons for each of said plurality of member businesses and each of said plurality of member buyers, thereby enabling each of said plurality of member businesses to monitor total sales from said coupons and enabling each of said plurality of member buyers to monitor total savings from said coupons.

18. The method of claim 1, further comprising the step of:
sending an email blast providing notification to said at least one of said plurality of member buyer of said coupon that is available from said at least one of said plurality of member businesses.

19. The method of claim 1, further comprising the step of:
awarding reward points to said at least one of said plurality of member buyers, wherein said reward points are redeemable as cash for purchases at said at least one of said plurality of member businesses and the trigger to initiate said awarding of said reward points is selected from the group consisting of referring a predetermined number of new member buyers or new member businesses, allowing said member buyer information to be used, completing periodic surveys from said plurality of member businesses, allowing email contact from said plurality of member businesses, and applying for a line of credit with a member credit provider.

20. A system for marketing and promoting goods or services from a plurality of member businesses to a plurality of member buyers, said system comprising:
an interface in the form of a web site configured to provide a plurality of web pages displayable to said plurality of member businesses and said plurality of member buyers;
an online accessible database associated with said interface, wherein said online accessible database performs the steps of:
receiving member business information from at least one of said plurality of member businesses;
storing said member business information in said online accessible database;
receiving member buyer information from at least one of said plurality of member buyers; and
storing said member buyer information in said online accessible database; and
a computer system associated with both said interface and said online accessible database, wherein said computer system performs the steps of:
receiving search criteria from said at least one of said plurality of member buyers;
searching said online accessible database for products or services matching said search criteria;
displaying a search results page to said at least one of said plurality of member buyers, wherein said search results page contains at least one search result;
providing a coupon link associated with each of said at least one search result;
receiving an election of said coupon link from said at least one of said plurality of member buyers;
populating a coupon associated with said coupon link with a unique code; and
providing said coupon in a printable format to said at least one of said plurality of member buyers.
